(19) United States
(12) Patent Application Publication
(10) Pub. No.: US 2017/0353626 A1
(43) Pub. Date: Dec. 7, 2017

(54) INFORMATION PROCESSING APPARATUS, NON-TRANSITORY COMPUTER READABLE RECORDING MEDIUM, AND INFORMATION PROCESSING METHOD

(71) Applicant: KYOCERA DOCUMENT SOLUTIONS INC., Osaka (JP)

(72) Inventor: HIROSHI NAKAMURA, OSAKA (JP)

(21) Appl. No.: 15/613,099

(22) Filed: Jun. 2, 2017

(30) Foreign Application Priority Data
Jun. 7, 2016 (JP) 2016-113554

(51) Int. Cl. H04N 1/44

(52) U.S. Cl. CPC H04N 1/4433; H04N 1/4426; H04N 1/4413; H04N 2201/0094

(57) ABSTRACT

An information processing apparatus includes: a memory that stores an information processing program; and a processor that executes the information processing program, in which when the processor executes the information processing program, the processor accepts a job execution instruction for executing a job, determines whether or not a user who is logged in has authority for executing the job, executes log-out of the user when determining that the user has the authority, and executes the job after executing the log-out of the user.

### CROSS REFERENCE TO RELATED APPLICATION

This application claims the benefit of Japanese Priority Patent Application JP2016-113554 filed Jun. 7, 2016, the entire contents of which are incorporated herein by reference.

### BACKGROUND OF THE INVENTION

### 1. Field of the Invention

The present disclosure relates to an information processing apparatus, which executes a function that needs to confirm user's authority, a non-transitory computer readable recording medium that stores a program, and an information processing method.

### 2. Description of Related Art

There is known a technology for performing user authentication by log-in or the like when executing a function that needs to confirm authority, and executing the function only in the case where a user who has been successfully authenticated has authority for executing the function. Further, there is also known a technology for displaying an authentication window when receiving input of a user name from a user before executing log-in of the user. The user can select only functions that he/she has authority for executing via the authentication window.

### SUMMARY OF THE INVENTION

In the above-mentioned technology, it is desirable to further improve security of an apparatus that a user logs in.

An information processing apparatus according to an embodiment of the present disclosure includes

a memory that stores an information processing program; and

a processor that executes the information processing program, in which

when the processor executes the information processing program, the processor

accepts a job execution instruction for executing a job,

determines whether or not a user who is logged in has authority for executing the job,

executes log-out of the user when determining that the user has the authority, and

executes the job after executing the log-out of the user.

A non-transitory computer readable recording medium according to an embodiment of the present disclosure stores a program. The program causes a computer of an information processing apparatus to:

accept a job execution instruction for executing a job;

determine whether or not a user who is logged in has authority for executing the job;

execute log-out of the user when determining that the user has the authority; and

execute the job after executing the log-out of the user.

An information processing method according to an embodiment of the present disclosure includes

accepting a job execution instruction for executing a job;

determining whether or not a user who is logged in has authority for executing the job;

executing log-out of the user when determining that the user has the authority; and

executing the job after executing the log-out of the user.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 shows a hardware configuration of an information processing apparatus according to a first embodiment of the present disclosure;

FIG. 2 shows a functional configuration of the information processing apparatus according to the first embodiment of the present disclosure;

FIG. 3 shows an operational flow of the information processing apparatus according to the first embodiment of the present disclosure;

FIG. 4 shows a window for selecting whether to execute log-out of a user or to continue a log-in state of the user;

FIG. 5 shows a functional configuration of an information processing apparatus according to a second embodiment of the present disclosure; and

FIG. 6 shows an operational flow of the information processing apparatus according to the second embodiment of the present disclosure.

### DETAILED DESCRIPTION OF THE PREFERRED EMBODIMENTS

Hereinafter, embodiments of the present disclosure will be described with reference to the drawings.

### I. First Embodiment

(1-1. Hardware Configuration of Information Processing Apparatus)

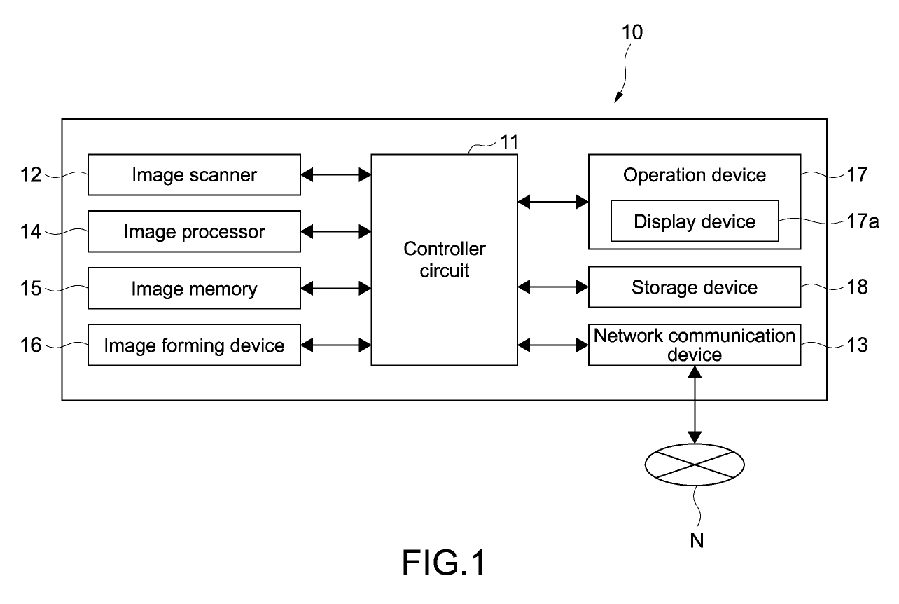

FIG. 1 shows a hardware configuration of an information processing apparatus according to a first embodiment of the present disclosure.

An information processing apparatus according to each of the embodiments of the present disclosure is an image forming apparatus (e.g., MFP; Multifunction Peripheral) and will hereinafter be referred to as MFP.

An MFP 10 includes a controller circuit 11. The controller circuit 11 includes a CPU (Central Processing Unit), a RAM (Random Access Memory), a ROM (Read Only Memory), dedicated hardware circuits, and the like and performs overall operational control of the MFP 10. A computer program that causes the MFP 10 to operate as the respective functional units (to be described later) is stored in a non-transitory computer readable recording medium such as a ROM.

The controller circuit 11 is connected to an image scanner 12, an image processor 14, an image memory 15, an image forming device 16, an operation device 17, a storage device 18, a network communication device 13, and the like. The controller circuit 11 performs operational control of the respective devices connected thereto and sends/receives signals and data to/from those devices.

According to job execution instructions input by a user via the operation device 17 or a personal computer (not shown) connected to a network N, the controller circuit 11 controls drive and processing of mechanisms requisite for executing operational control of functions such as a scanner function, a printing function, and a copy function.

The image scanner 12 reads an image from a script.

The image processor 14 carries out image processing as necessary on image data of an image read by the image scanner 12. For example, the image processor 14 corrects shading of an image read by the image scanner 12 and carries out other image processing to improve the quality of the image to be formed.

The image memory 15 includes an area that temporarily stores data of a script image read by the image scanner 12 or data to be printed by the image forming device 16.

The image forming device 16 forms an image of image data and the like read by the image scanner 12.

The operation device 17 includes a touch panel device and an operation key device that accept user's instructions on various operations and processing executable by the MFP 10. The touch panel device includes a display device 17a such as an LCD (Liquid Crystal Display) equipped with a touch panel.

The network communication device 13 is an interface used for connecting to the network N.

The storage device 18 is a large-volume storage device such as an HDD (Hard Disk Drive) that stores a script image read by the image scanner 12, and the like.

(1-2. Functional Configuration of Information Processing Apparatus)

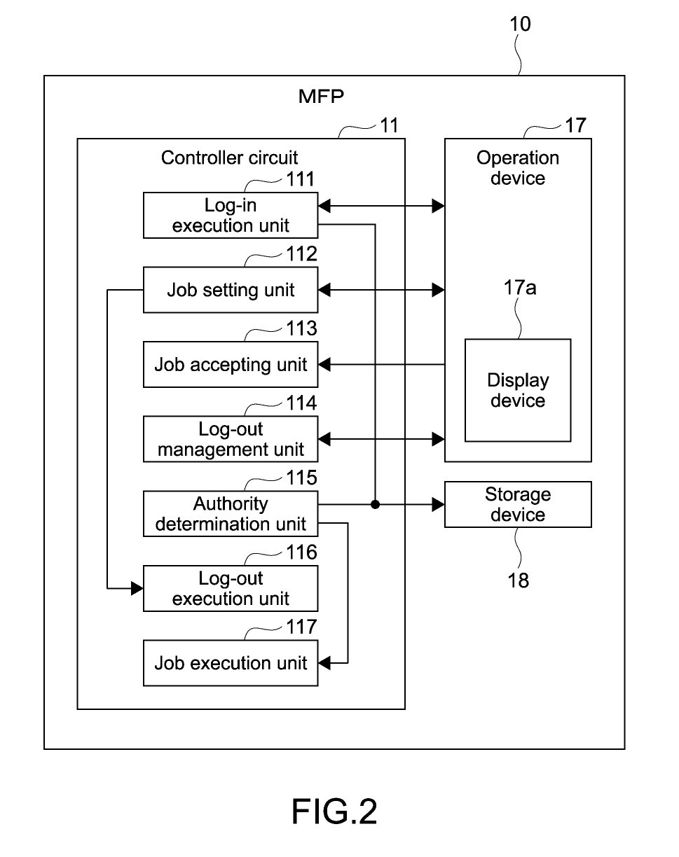

FIG. 2 shows a functional configuration of the information processing apparatus according to the first embodiment of the present disclosure.

The CPU (processor) of the controller circuit 11 of the MFP 10 loads an information processing program stored in a ROM (memory), which is an example of a non-transitory computer readable recording medium, in a RAM and executes the programs to thereby operate as the functional blocks, i.e., a log-in execution unit 111 (log-in execution circuit), a job setting unit 112 (job setting circuit), a job accepting unit 113 (job accepting circuit), a log-out management unit 114 (log-out management circuit), an authority determination unit 115 (authority determination circuit), a log-out execution unit 116 (log-out execution circuit), and a job execution unit 117 (job execution circuit).

The log-in execution unit 111 executes log-in of a user.

The job setting unit 112 executes job setting.

The job accepting unit 113 detects job execution instructions input by a user.

The log-out management unit 114 determines whether to execute log-out of the user or to continue a log-in state of the user.

The authority determination unit 115 determines whether or not the user has authority for executing the job.

The log-out execution unit 116 executes log-out of the user.

The job execution unit 117 executes the job.

(1-3. Operation of Information Processing Apparatus)

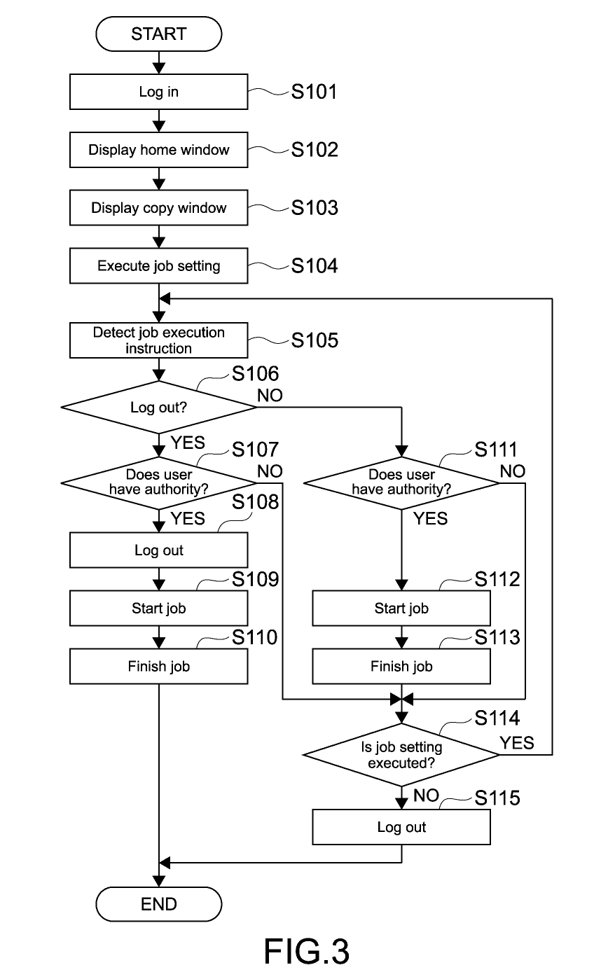

FIG. 3 shows an operational flow of the information processing apparatus according to the first embodiment of the present disclosure.

The log-in execution unit 111 executes log-in of a user of the MFP 10 (Step S101). Specifically, the log-in execution unit 111 causes the display device 17a to display a log-in window for performing user authentication. The log-in execution unit 111 detects, for example, a user ID and a password input by a user via the operation device 17. The log-in execution unit 111 performs user authentication by respectively comparing the detected user ID and password with a user ID and a password registered in the storage device 18. In the case where the user authentication has succeeded, the log-in execution unit 111 executes log-in of the user.

When the log-in execution unit 111 performs log-in of the user, the job setting unit 112 causes the display device 17a to display a home window (Step S102). The “home window” is a window for presenting jobs (copy, scan, and the like) that the MFP 10 can execute. The job setting unit 112 detects a particular user operation input in the operation device 17 as a request for displaying a window for performing detail setting (job setting) of any of j obs displayed on the home window. In this example, the job setting unit 112 detects a request for display a window for performing detail setting of copy job (copy window). When the job setting unit 112 detects the request for displaying the copy window, the job setting unit 112 causes the display device 17a to display the copy window (Step S103). When the job setting unit 112 causes the display device 17a to display the copy window, the job setting unit 112 detects a job setting request input by the user via the operation device 17. The job setting unit 112 executes job setting based on the detected job setting request (Step S104). Specifically, the job setting unit 112 sets either monochrome or color, concentration, magnification, paper size, and the like, as detail setting (job setting) of the copy job.

The job accepting unit 113 detects an execution instruction (job execution instruction) of a copy job input by the user via the operation device 17 (hereinafter, referred to simply as “job”) (Step S105). Specifically, the job accepting unit 113 detects, as the job execution instruction, that the user operates a start button for starting the job.

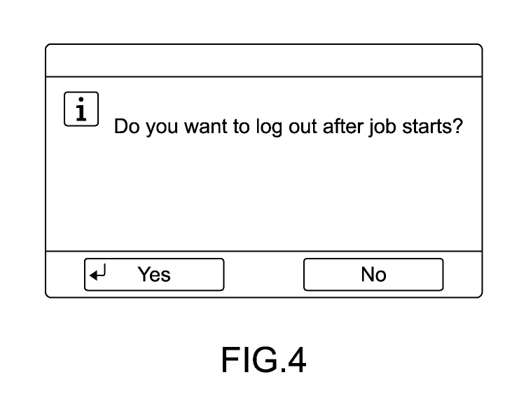

When the job accepting unit 113 detects the job execution instruction, the log-out management unit 114 determines whether to execute log-out of the user or to continue a log-in state of the user (Step S106). Accordingly, it is possible to reliably determine whether to execute log-out of the user or not before executing the job (in other words, before the user goes away from the MFP 10). Specifically, the log-out management unit 114 causes the display device 17a to display a window for selecting whether to execute log-out of the user or to continue the log-in state as shown in FIG. 4 (selection window). The log-out management unit 114 detects a particular user operation input in the operation device 17 as a request for selecting execution of log-out (log-out request). For example, the log-out management unit 114 detects, as the log-out request, that the user selects “Yes” in the selection window shown in FIG. 4. When the log-out management unit 114 detects the log-out request, the log-out management unit 114 determines to execute log-out of the user. The log-out management unit 114 detects a particular user operation input in the operation device 17 as a request for selecting continuing of the log-in state (log-in continuing request). When the log-out management unit 114 detects the log-in continuing request, the log-out management unit 114 determines to continue the log-in state of the user. For example, the log-out management unit 114 detects, as the log-in continuing request, that the user selects “No” in the selection window shown in FIG. 4.

When the log-out management unit 114 determines to perform log-out of the user (Step S106: Yes), the authority determination unit 115 determines whether or not the user has authority for executing the job of which the job accepting unit 113 has accepted the execution instruction (Step S107). For example, in the storage device 18, a user ID and a job name of a job that the user has authority for executing are stored in relation to each other. The authority determination unit 115 refers to the storage device 18, searches for the user ID of the log-in user, and determines, in the case where the job name stored in relation to the user ID and the job of which the job accepting unit 113 has accepted the execution instruction match, that the user has authority for executing the job. The authority determination unit 115 determines that the user has authority for executing the job also in the case where the job of which the job accepting unit 113 has accepted the execution instruction is a job that does not need to confirm authority (job that any user can execute). For example, examples of the job that needs to confirm authority include color copy. Meanwhile, examples of the job that does not need to confirm authority include monochrome copy.

When the authority determination unit 115 determines that the user has authority for executing the job (Step S107: Yes), the log-out execution unit 116 executes log-out of the user (Step S108). When the log-out execution unit 116 executes the log-out of the user, the log-out execution unit 116 notifies the job execution unit 117 of that the log-out execution unit 116 has executed the log-out of the user.

When the job execution unit 117 is notified of that the log-out execution unit 116 has executed the log-out of the user from the log-out execution unit 116, the job execution unit 117 starts execution of the job of which the job accepting unit 113 has accepted the execution instruction (Step S109). When the job execution unit 117 finishes the execution of the job (Step S110), the MFP 10 finishes the processing.

Meanwhile, in the case where the log-out management unit 114 determines to continue the log-in state of the user (Step S106: No), the log-out execution unit 116 does not execute log-out (which is different from Step S108), and the authority determination unit 115 determines whether or not the user has authority for executing the job (Step S111). The authority determination unit 115 determines whether or not the user who logs in the MFP 10 has authority for executing the job, similarly to Step S107. When the authority determination unit 115 determines that the user has authority for executing the job (Step S111: Yes), the authority determination unit 115 notifies the job execution unit 117 of that the user has authority for executing the job.

When the job execution unit 117 is notified of that the user has authority for executing the job from the authority determination unit 115, the job execution unit 117 starts execution of the job of which the job accepting unit 113 has accepted the execution instruction (Step S112). When the job setting unit 112 detects a job setting request newly input from the user via the operation device 17 (Step S114: Yes) after the job execution unit 117 finishes the execution of the job (Step S113), the MFP 10 executes the operation of Step S105 and subsequent Steps again. Meanwhile, in the case where the job setting unit 112 does not detect a new job setting request within a particular time period (Step S114: No), the log-out execution unit 116 executes log-out of the user (Step S115).

(1-4. Conclusion)

According to the present embodiment, immediately after determining whether or not a user who is logged in has authority for executing a particular job, the MFP executes log-out of the user, and then executes the job.

In order to determine whether or not a user has authority for executing a particular job, it is necessary that the user is logged in, but after determining the presence/absence of the authority, it is not necessary that the user is logged in. Therefore, according to the present embodiment, when it is not necessary that the user is logged in (when determining the presence/absence of the authority), the MFP immediately executes log-out of the user. Accordingly, it is possible to reduce the continuing time of the log-in state and improve the security.

Typically, when the MFP executes a job while continuing a log-in state of a user, the user may go away from the MFP without logging out after executing the job. In this case, another user can use the MFP that continues the log-in state of the user, which causes a security problem.

In contrast, in the present embodiment, the MFP executes log-out of the user and then executes the job. In other words, because the user is already logged out at the time when the MFP executes the job, there is no risk that the user goes away from the MFP without logging out after executing the job. Therefore, it is possible to eliminate the possibility that another user uses the MFP that continues the log-in state of the user. As a result, it is possible to prevent another user from executing a function that needs to confirm authority by illegally using the log-in state of the user, thereby improving the security.

Meanwhile, in the case where the log-out management unit 114 determines to continue the log-in state of the user, the log-out execution unit 116 does not execute log-out of the user. Therefore, the user can newly execute job setting while continuing the log-in state. If log-out is always executed before executing a job, it takes much trouble to execute log-in of the user again in the case where the user wants to continuously use the MFP 10 after execution of one job is finished. In contrast, according to the present embodiment, in the case where the user wants to continuously use the MFP 10 after execution of one job is finished, it is possible to reduce the trouble of having to execute log-in of the user again. Meanwhile, even in the case where the log-out management unit 114 determines to continue the log-in state of the user, the MFP 10 executes log-out after a particular time period. Therefore, it is possible to maintain the security.

### II. Second Embodiment

In the following embodiments and modified examples, descriptions on configurations, operations, and the like similar to those described above will be omitted, and different points will be mainly described.

According to the first embodiment, the MFP determines whether or not a user has authority for executing a job based on a log-in state of the user (Step S101). In contrast, according to the second embodiment, first, the MFP determines whether or not there is a need to determine presence/absence of authority for executing a job to be executed. Then, only after the MFP determines that there is a need to determine the presence/absence of the authority for executing the job, the MFP executes log-in of the user.

(2-1. Functional Configuration of Information Processing Apparatus)

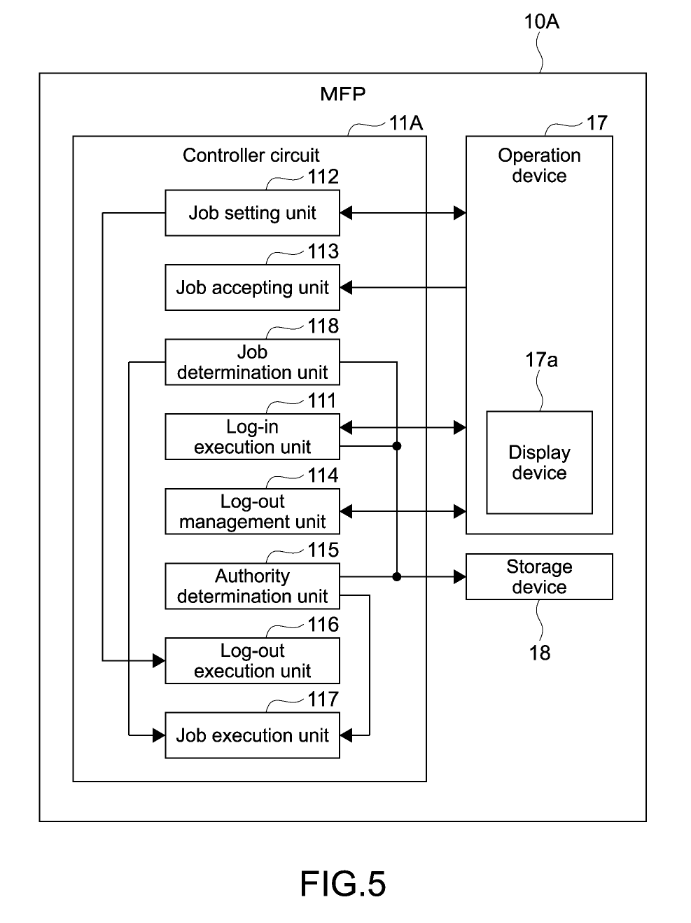

FIG. 5 shows a functional configuration of an information processing apparatus according to a second embodiment of the present disclosure.

The controller circuit 11 of an MFP 10A loads information processing programs stored in a ROM or the like, which is an example of a non-transitory computer readable recording medium, in a RAM and executes the programs to thereby operate as the functional blocks, i.e., the job setting unit 112 (job setting circuit), the job accepting unit 113 (job accepting circuit), a job determination unit 118 (job determination circuit), the log-in execution unit 111 (log-in execution circuit), the log-out management unit 114 (log-out management circuit), the authority determination unit 115 (authority determination circuit), the log-out execution unit 116 (log-out execution circuit), and the job execution unit 117 (job execution circuit).

The job setting unit 112 executes job setting.

The job accepting unit 113 detects job execution instructions input by a user.

The job determination unit 118 determines whether or not there is a need to determine presence/absence of authority for executing a j ob.

The log-in execution unit 111 executes log-in of the user.

The log-out management unit 114 determines whether to execute log-out of the user or to continue a log-in state of the user.

The authority determination unit 115 determines whether or not the user has authority for executing the job.

The log-out execution unit 116 executes log-out of the user.

The job execution unit 117 executes the job.

(2-2. Operation of Information Processing Apparatus)

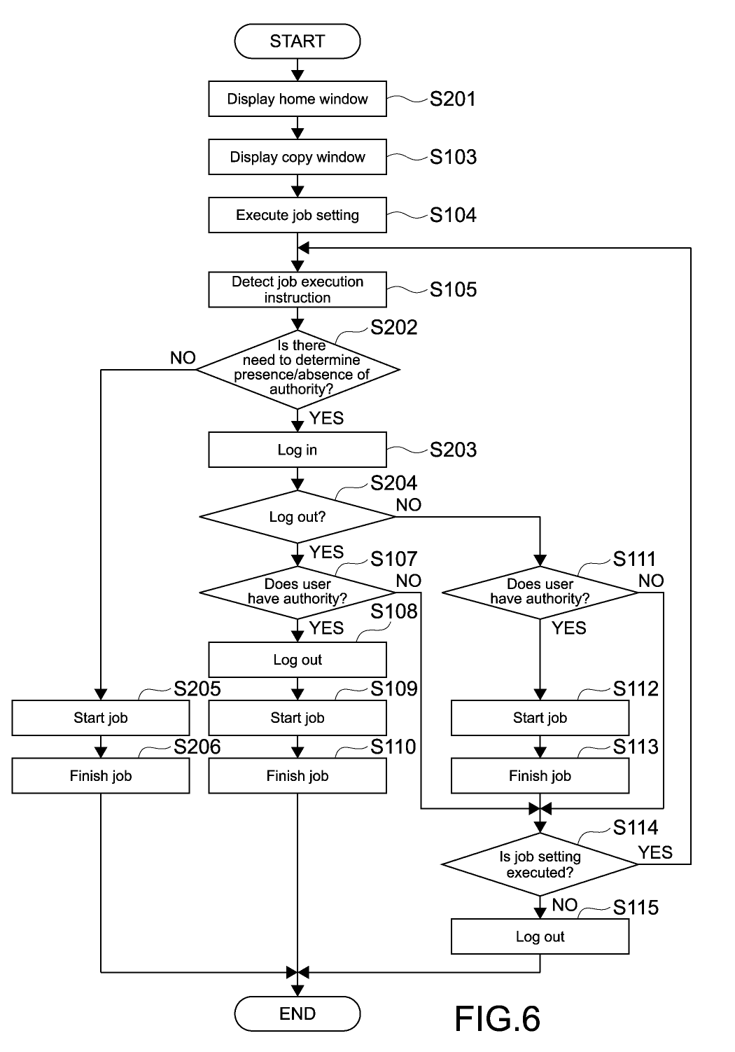

FIG. 6 shows an operational flow of the information processing apparatus according to the second embodiment of the present disclosure.

The job setting unit 112 causes the display device 17a to display a home window (Step S201). Unlike the first embodiment, at this point, the log-in execution unit 111 has not executed log-in of a user.

Steps from Step S103 to Step S105 are the same as those of the first embodiment.

When the job accepting unit 113 detects a job execution instruction (Step S105), the job determination unit 118 determines whether or not there is a need to determine presence/absence of authority for executing the job of which the job accepting unit 113 has accepted the job execution instruction (Step S202). Specifically, in the storage device 18, jobs that need to determine presence/absence of authority for executing the job are stored. The job determination unit 118 refers to the storage device 18, and searches for the job of which the job accepting unit 113 has accepted the execution instruction. When the job determination unit 118 detects, from the storage device 18, the job of which the job accepting unit 113 has accepted the execution instruction, the job determination unit 118 determines that there is a need to determine presence/absence of authority for executing the job. Meanwhile, when the job determination unit 118 cannot detect, from the storage device 18, the job of which the job accepting unit 113 has accepted the execution instruction, the job determination unit 118 determines that there is no need to determine presence/absence of authority for executing the job. Examples of the job that needs to determine presence/absence of authority include color copy. Examples of the job that does not need to determine presence/absence of authority include monochrome copy.

When the job determination unit 118 determines that there is a need to determine presence/absence of authority for executing the job of which the job accepting unit 113 has accepted the execution instruction (Step S202: Yes), the log-in execution unit 111 executes log-in of the user (Step S203), similarly to Step S101.

When the log-in execution unit 111 executes log-in of the user, the log-out management unit 114 determines whether to execute the log-out of the user or not (Step S204), similarly to Step S106 in the first embodiment.

Steps from Step S107 to Step S115 are the same as those in the first embodiment.

Meanwhile, the job determination unit 118 determines that there is no need to determine presence/absence of authority for executing the job of which the job accepting unit 113 has accepted the execution instruction (Step S202: No), the job determination unit 118 notifies the job execution unit 117 of that there is no need to determine presence/absence of authority for executing the job of which the job accepting unit 113 has accepted the execution instruction. When the job execution unit 117 is notified, from the job determination unit 118, of that there is no need to determine presence/absence of authority for executing the job of which the job accepting unit 113 has accepted the execution instruction, the job execution unit 117 starts execution of the job of which the job accepting unit 113 has accepted the execution instruction (Step S205). When the job execution unit 117 finishes the execution of the job (Step S206), the MFP 10 finishes the processing.

(2-3. Conclusion)

According to the present embodiment, first, the MFP determines whether or not there is a need to determine presence/absence of authority for executing a job to be executed. Then, only after the MFP determines that there is a need to determine the presence/absence of the authority for executing the job, the MFP executes log-in of the user. In other words, the MFP does not execute log-in of the user before executing a job that needs to confirm authority. Accordingly, it is possible to execute log-in of a user at the slowest timing. Therefore, by delaying the timing of log-in at the most, it is possible to reduce the continuing time of a log-in state of the user at the most and further improve the security.

Further, according to the present embodiment, when the MFP determines that there is no need to determine presence/absence of authority for executing a job, the MFP does not execute log-in of a user and executes the job. Therefore, it is possible to further improve the security.

### 3. Modified Example

In the first embodiment, the MFP executes log-in of the user when starting operation (Step S101). This is an example where it is only necessary that the user is logged in at the time when determining whether or not the user has authority for executing a job. The MFP does not necessarily need to execute log-in of the user at the time when starting operation. In other words, on the assumption that the user is logged in, the MFP only needs to determine whether or not the user has authority for executing the job. For example, the MFP may execute log-in of the user after accepting a job execution instruction.

In the above-mentioned embodiments, log-in of a user is executed by detecting a user ID and password input from the user via the operation device 17. Instead of this, for example, an IC card reader may be provided to the MFP and log-in of a user may be executed by the IC card reader reading an IC card held over the IC card reader by the user.

In the above-mentioned embodiments, it may be displayed on the copy window that the job needs to confirm authority.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a memory that stores an information processing program; and
a processor that executes the information processing program, wherein
when the processor executes the information processing program, the processor
accepts a job execution instruction for executing a job,
determines whether or not a user who is logged in has authority for executing the job,
executes log-out of the user when determining that the user has the authority, and
executes the job after executing the log-out of the user.

2. The information processing apparatus according to claim 1, wherein
when the processor executes the information processing program, the processor
determines whether to execute the log-out of the user or to continue a log-in state of the user after accepting the job execution instruction, and
when determining to execute the log-out of the user,
executes the log-out of the user when determining that the user has the authority, and
executes the job after executing the log-out of the user.

3. The information processing apparatus according to claim 2, wherein
when the processor executes the information processing program, the processor
when determining to continue the log-in state of the user,
executes the job when determining that the user has the authority, and
executes the log-out of the user where the information processing apparatus accepts no request for executing another job within a particular time period.

4. The information processing apparatus according to claim 1, wherein
when the processor executes the information processing program, the processor
determines whether or not there is a need to determine presence/absence of the authority for executing the job when accepting the job execution instruction, and
executes log-in of the user when determining that there is a need to determine the presence/absence of the authority for executing the job.

5. The information processing apparatus according to claim 4, wherein
when the processor executes the information processing program, the processor
executes the job without executing the log-in of the user when determining that there is no need to determine the presence/absence of the authority for executing the job.

6. A non-transitory computer readable recording medium that stores a program, the program causing a computer of an information processing apparatus to:
accept a job execution instruction for executing a job;
determine whether or not a user who is logged in has authority for executing the job;
execute log-out of the user when determining that the user has the authority; and
execute the job after executing the log-out of the user.

7. An information processing method, comprising:
accepting a job execution instruction for executing a job;
determining whether or not a user who is logged in has authority for executing the job;
executing log-out of the user when determining that the user has the authority; and
executing the job after executing the log-out of the user.
